(19) United States
(12) Patent Application Publication
(10) Pub. No.: US 2004/0022231 A1
(43) Pub. Date: Feb. 5, 2004

(54) Time diversity techniques

(76) Inventors: John Morrish, Glasgow (GB); Jean-Marc Villevieille, Phoenix, AZ (US); Ali Shoamanesh, Ottawa (CA)

Correspondence Address: John Morrish, Global Radio, S.A., 33 Parc d'Activite Syrdall, L-5365 Munsback, Luxembourg, BE

(21) Appl. No.: 10/207,049

(22) Filed: Jul. 30, 2002

(51) Int. Cl. H04J 3/24

(52) U.S. Cl. 370/349

(57) ABSTRACT

A digital audio broadcasting system (DAB) includes a transmitter configured to transmit a DAB multiplex to one or more mobile receivers. The DAB multiplex includes a live payload and a time diversity “early” signal to circumvent temporary obstruction and loss of a main live signal. Techniques are provided for minimizing the amount of bandwidth used by the time diversity signal in the DAB multiplex in order to maximize the available amount of content channels in a spectrum-limited, satellite, digital, radio broadcast to mobile receivers. The time diversity signal may be minimized by limiting the amount of data in the time diversity signal to a predetermined amount, by transmitting mono, audio data in the time diversity signal and/or by eliminating the time diversity signal when non-real time data is being transmitted.

### FIELD OF THE INVENTION

The invention is generally related to data transmission. More particularly, the invention is related to time diversity techniques for data transmission.

### BACKGROUND OF THE INVENTION

Communications satellites are often used as relay stations and may re-broadcast media content, such as radio or television programming, from a service provider. In addition to well known satellite television broadcasting, satellite digital audio broadcasting (“DAB”), which includes radio programming and can include text, still data, images and narrow band video, is becoming increasing popular worldwide.

Various transmission techniques are used for satellite broadcasting. Time diversity is a satellite transmission technique that may be used to mitigate the effects of a “hard” temporary obstruction (e.g., overpass, short tunnels, buildings, etc.) on a radio frequency (RF) signal transmitted from a satellite. This technique typically involves interleaving a duplicate of a future packet with a current data packet payload of a digital program. The future packet may be time-shifted by a predetermined duration (e.g., “x” seconds) from the original data packet payload.

Typically, a receiver extracts the time-shifted data from received packets, and the extracted time-shifted packet stream is stored in a buffer until it becomes necessary for the receiver to use it when the main signal is obstructed. The length of the time-shift duration of “x” seconds depends on the tolerance to obstruction and the buffer characteristics of the receiver. A buffer length of a few seconds may allow clearing most overpass obstructions at a speed of approximately 10 mph for a mobile receiver.

Although the current time diversity technique mitigates effects of a “hard” temporary obstruction, this technique effectively reduces the available bandwidth for transmission of media content by 2 (i.e., a 50% reduction in bandwidth capacity). The reduction of bandwidth is especially problematic when a significant amount of media content is transmitted, such as for DAB which may include 200 or more channels of programming.

### SUMMARY OF THE INVENTION

According to an embodiment of the invention, a method of generating a signal for transmitting media content includes generating a live payload including digital, audio, media content, and generating a time diversity signal. The time diversity signal includes mono audio data associated with the digital audio media content. The method further comprises transmitting the live payload and the time diversity signal.

According to another embodiment of the invention, a method of generating a signal for transmitting media content includes generating a live payload including media content, and generating early time-shifted data for a time diversity signal associated with the media content. The method further comprises setting a minimum amount of data for forward error correction associated with the early time-shifted data, and generating the forward error correction data. The amount of the forward error correction generated for the early time-shifted data is greater than or equal to the set minimum amount.

According to yet another embodiment of the invention, a method of generating a signal for transmitting media content includes determining whether the media content includes real time data, generating a live payload and a time diversity signal for transmitting the media content in response to the media content including real time data, and generating a live payload without a time diversity signal in response to the media content being non-real time data.

According to yet another embodiment of the invention, a transmitter operable to generate a signal for transmitting media content includes a processing means for determining whether the media content includes real time data and for generating a live payload and a time diversity signal in response to the media content including real time data, and a transmitting means for transmitting the live payload and the time diversity signal.

### BRIEF DESCRIPTION OF THE DRAWINGS

The invention is illustrated by way of example and not limitation in the accompanying figures in which like numeral references refer to like elements, and wherein:

FIG. 1 illustrates an exemplary system according to an embodiment of the invention;

FIG. 2 illustrates DAB multiplex payload data with redundant early data;

FIG. 3 illustrates a flow chart of a method, according to an embodiment of the invention, for minimizing an amount of early time-shifted data in a time diversity signal;

FIG. 4 illustrates a flow chart of a method, according to an embodiment of the invention, for minimizing an amount of channel coding for early time-shifted data in a time diversity signal;

FIG. 5 illustrates a flow chart of an exemplary method, according to an embodiment of the invention;

FIG. 6 illustrates a flow chart of an exemplary method, according to an embodiment of the invention;

FIG. 7 illustrates an exemplary DAB transmitter, according to an embodiment of the invention; and

FIG. 8 illustrates an exemplary DAB receiver according to an embodiment of the invention.

### DETAILED DESCRIPTION OF THE INVENTION

In the following detailed description, numerous specific details are set forth in order to provide a thorough understanding of the invention. However, it will be apparent to one of ordinary skill in the art that these specific details need not be used to practice the invention. In other instances, well known structures, interfaces, and processes have not been shown in detail in order not to unnecessarily obscure the invention.

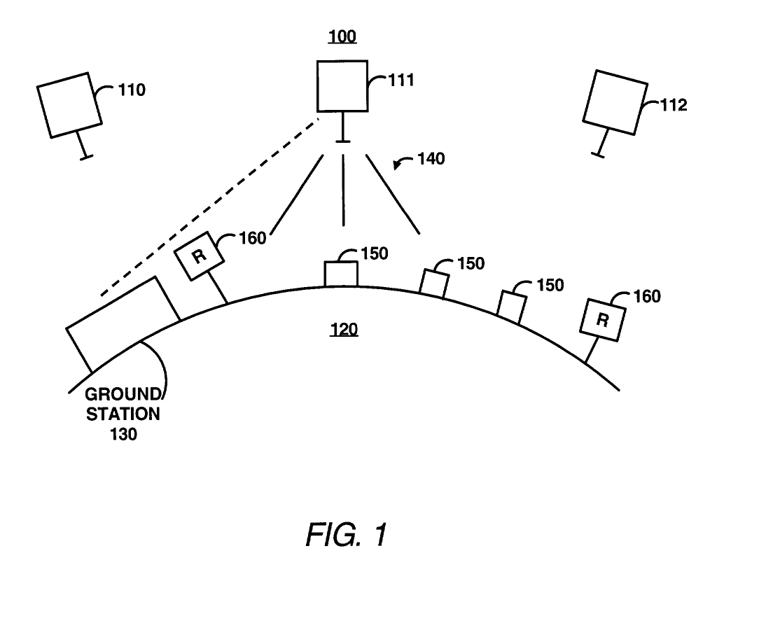

FIG. 1 illustrates an exemplary satellite system 100 employing principles of the invention. A plurality of satellites 110-112 orbit the Earth 120. The satellites 110-112 broadcast media content to the Earth 120. The satellites 110-112 may receive the media content from a ground station 130 and transmit the media content to a coverage area on the Earth 120 using one or more satellites beams. For example, the satellite 111 receives media content from the ground station 130 and transmits the media content to multiple receivers 150 in the coverage area using one or more beams 140. Multiple repeaters 160 on the Earth 120 may be used to increase signal strength and quality and to expand the coverage area. The number of satellites used in the system 100 may vary (e.g., one or a plurality) based on a variety of factors, including but not limited to, the intended coverage area and the number of beams needed to transmit the media content.

In one embodiment, the system 100 is a mobile DAB system, and the satellites 110-112 provide DAB media content to users on the Earth 120. The DAB media content primarily includes audio content provided on a plurality of channels to users. The DAB media content may also include text, data, images, video, etc.

The satellites 110-112 may utilize one of a variety of orbiting schemes to provide the necessary coverage. In one embodiment, the satellites 110-112 travel in highly elliptical orbits (HEOs), such as described in U.S. Provisional Application Ser No. (TBD) (Attorney Docket No. 319345.0005), entitled A Highly Elliptical Orbit For Communication Satellites, herein incorporated by reference. The HEO orbit may be a lower inclination variation of a tundra orbit having a teardrop shaped ground track and an inclination approximately between 53 degrees and 57 degrees. The satellite following the lower inclination HEO orbit may be a part of a satellite constellation (e.g., satellites 110-112 may form a satellite constellation). The satellite constellation may include, for example, a three-satellite, four-satellite, six-satellite or 8-satellite constellation. For example, the satellite constellation may be initially implemented as a three-satellite constellation, and three more satellites may be launched later to form a six-satellite constellation. Multiple satellite constellations may also be used. In another embodiment, such technique may be also applied to a single geostationary satellite or multiple geostationary satellites as it is not directly dependant on satellite elevation.

In one embodiment, the satellites 110-112 may generate multiple overlapping beams for transmitting DAB media content or other media content to users. Schemes utilizing multiple overlapping beams are described in U.S. patent application Ser. No. ______ (TBD) (Attorney Docket No. 319345.0007), entitled Combination Of Multiple Regional Beams And A Wide-Area Beam Provided By A Satellite System and herein incorporated by reference. The coverage area and media content provided by the system 100 can be optimized to meet market demand. To the extent this demand changes over time, the beam patterns and channel plans can be dynamically adjusted accordingly, by moving a beam or creating a new beam over another part of the coverage area without violating the frequency reuse requirements.

The HEOs embodiment and the multi-beam embodiment are provided by way of example and not limitation. The time diversity techniques of the invention may be employed in a variety of systems, including satellite systems regardless of the number of beams and elevation/orbit of satellites.

The satellites 110-112 may utilize time diversity compression techniques, according to embodiments of the invention, that maximize bandwidth for transmitting media content to the receivers 150. These techniques are especially applicable to mobile DAB broadcasting, but may be used and/or modified for transmitting mobile information other than DAB media content. Furthermore, the compression techniques described below, according to embodiments of the invention, may be used in systems other than satellite systems. For example, DAB broadcasting may be used on terrestrial or satellite networks, and compression techniques, according to embodiments of the invention, may be used on any of these types of mobile networks, where mobile receivers may become blocked from receiving a transmission.

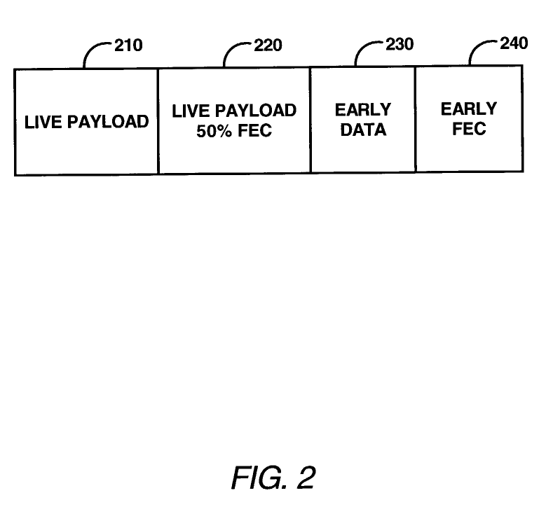

As illustrated in FIG. 2, a DAB multiplex 200 is approximately 2.3 Mbps and includes a live payload 210, associated channel coding overhead 220 (e.g., forward error correction (FEC) data), early time-shifted data 230, and its associated channel coding overhead 240 (e.g., FEC data for the early time-shifted data 230). The DAB multiplex 200 may be divided into a plurality of channels for carrying audio information and other content. Also, a DAB multiplex is typically transmitted in a DAB multiplex frame (not shown), which includes other information (e.g., a synchronization channel and a fast information channel (FIC) giving a detailed index of the composition of sub-channels within the multiplex).

The early time-shifted data 230 and the associated overhead 240 may be placed in an external memory buffer (typically a buffer may store up to 4 seconds of data) in a receiver, such as the receiver 150 shown in FIG. 1. The early time-shifted data stored in the buffer may be recalled in case of obstruction of a signal broadcast from a satellite, such as the satellite 110. The early time-shift data 230 may have reduced error correction overhead 240. From a digital signal processing power, this, for example, equates to sampling a total of 144 kbits per second out of a true music channel stereo payload of 48 kbps (48 kbps for live payload, 48 kbps for Live FEC, 24 kbps for “early” signal, 24 kbps or less for “early FEC”), which is well within range of typical DAB receivers (e.g., decoding from 384 kbps to a full 2.3 Mbps worth of programs).

To maximize use of available bandwidth, compression of time-diversity data information may be achieved through three techniques. In a first embodiment, audio data is compressed for the early time-shifted data 230. In a second embodiment, the channel coding overhead 240 for the early time-shifted data 230 is minimized to increase effectively the bandwidth used for programming data. In a third embodiment, time-diversity (e.g., the early time-shifted data 230 and the associated overhead 240) is removed for data packets that are broadcasted and updated through a “data carrousel update” technique repeated over time and therefore providing a natural “time diversity” on a longer recurring time (e.g., updates every 20 minutes). These embodiments may be used individually or one or more of these embodiments may be combined. All these techniques individually or compounded are able to achieve at least a 40% improvement in channel programming capacity for DAB over the conventional time diversity technique.

In the first embodiment, digital radio programming is compressed to increase the utilization of the bandwidth. Most of the digital audio broadcast channels are broadcasted in stereo at a rate of 2×24 kbps to 2×64 kbps. Early audio data (e.g., the early time-shifted data 230) is broadcasted in at least half of its original resolution. For example, instead of stereo, mono audio data is transmitted for the early time-shifted data, guaranteeing at least 50% bandwidth savings for the time diversity signal. If needed, the mono audio data may be duplicated to simulate a stereo signal without the spatial correlation.

The minimum length of a DAB multiplex frame is about 24 ms, which equates to 1/10th of a spoken syllable. If hard shadowing or obstruction of a line of sight (LOS) satellite signal is encountered, the time diversity signal that has been previously broadcasted (e.g., early time-shifted data 230 and associated overhead 240) will be used and substituted for the missing stereo frames. The loss of quality between the stereo and mono signal is almost imperceptible, especially for highly compressed audio signals, such as Advanced Audio Coding and Spectral Band Replication, where compressed stereo already takes advantage of spatial sound “common mode” behavior and some mono signals replicate “side band stereo informations” to give the user a stereo image perception. Furthermore, since the frequency and recurrence of these obstructions are typically few and far apart in a regular mobile environment, these transitions become more imperceptible to average listeners, especially in the case of high elevation satellites where obstructions are generally limited (e.g., tunnels, overpasses and high-rise buildings).

In the second embodiment, the amount of FEC coding in the early overhead 240 is minimized to save bandwidth. Statistically, the early time-shifted data 230 is not often used, and thus minimally impacts over all quality of service (QoS) target numbers for a DAB system. These statistics increase when highly elliptical orbits are used for the satellites 110-112, which minimizes obstructions. In this embodiment, the amount of channel coding (i.e., FEC) in the overhead 240 for the early time-shifted data 230 is reduced to conserve bandwidth.

Traditionally, in digital communication systems, the FEC overhead rate ranges between ⅓ to ⅔ bits of the total payload. For example, for every 3 bits of total payload, one bit is channel coding overhead and 2 bits are “true” data (i.e., ⅔). For ⅓, 2 bits of channel coding overhead are used for every bit of “true” data.

The FEC typically uses resources which could have been used for the payload (e.g., between half and twice the early time-shifted data 230 is duplicated in the FEC for the overhead 240) in order to increase the availability of the programming. According to an embodiment of the invention, the overhead 240 may be approximately half of the early time-shifted data 240, and the QoS may be maintained at sufficient levels. For example, a ⅔ coding rate may reduce by approximately IdB the Eb/No performances (i.e., the signal to noise ratio) for a DAB signal, but it is likely to be enough in a non-heavily obstructed situation and statistically insignificant from an availability stand point. This results in a possible 20% savings on true available bandwidth for channels.

In the third embodiment, time diversity (i.e., early time-shifted data 230 and the overhead 240) is not provided for every type of data that may be included in the live payload 210. This embodiment may include analyzing the type of content that is being broadcasted to determine whether time diversity is needed. For a DAB system, in addition to audio and narrow band video entertainment broadcast, non real-time data may be broadcasted. Because of the nature of this type of data (e.g., weather, news, information flashes, stocks updates, etc.), this data may be refreshed on a recurring basis (e.g., every 5 to 20 minutes or on the hour). This data refreshing technique, sometimes referred as a “data carrousel” technique, provides multiple chances for data to be broadcasted and stored by the receiver. For this type of content, using the time diversity technique would likely be an efficient use of resources. For example, a worst-case may include a receiver, such as one of the receivers 150, not receiving the last updated event. The receiver may then wait for the next broadcast of the data (e.g., 5 to 20 minutes) that would statistically happen in a more friendly situation (either line of sight for the main signal or non shaded early signal broadcast). All combined, these techniques can allow the system 100 to save an average of 43% in bandwidth.

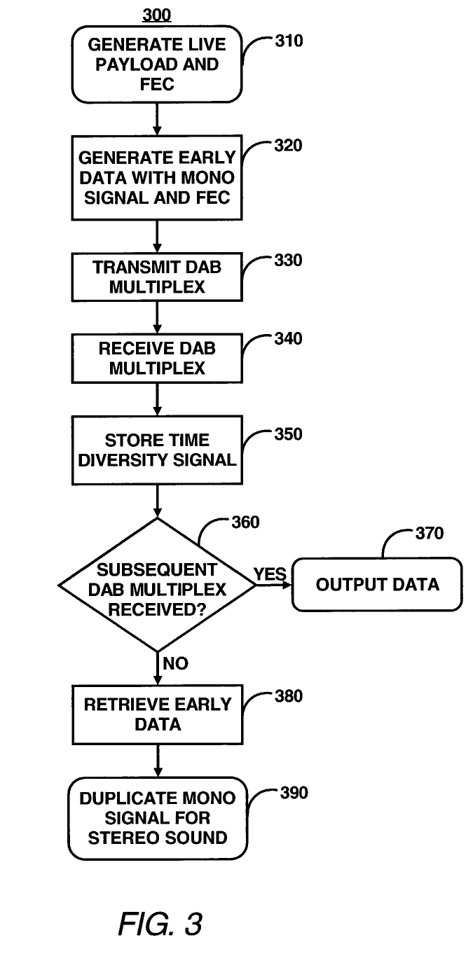

FIG. 3 illustrates a flow diagram of a method 300 for reducing the amount of early time-shifted data in a DAB multiplex, according to an embodiment of the invention. In step 310, a DAB transmitter generates a live payload and associated FEC overhead for the live payload (e.g., live payload data 210 and associated overhead 220, shown in FIG. 2) to be transmitted in a DAB multiplex. In step 320, the DAB transmitter generates early time-shifted data (e.g., the early time-shifted data 230, shown in FIG. 2) for a time diversity signal to be transmitted in the DAB multiplex. The early time-shifted data includes mono digital audio data instead of stereo digital audio data to minimize the amount of early time-shifted data in the DAB multiplex. In step 330, the DAB transmitter transmits the DAB multiplex to DAB receivers.

In step 340, a DAB receiver receives the DAB multiplex and stores the early time-shifted data from the time diversity signal in memory (step 350). In step 360, the receiver determines whether it received a subsequently generated DAB multiplex. For example, the receiver may expect to receive a DAB multiplex periodically. If the DAB multiplex is not received, for example, due to an obstruction, the DAB receiver retrieves the previously received early time-shifted data, including mono audio data, from the memory (step 380). The DAB receiver duplicates the mono signal to generate a stereo signal for audio output (step 390). If the subsequent DAB multiplex is received, as determined in step 360, the receiver outputs the received data, such as generating audio output of audio data in the received DAB multiplex (step 370).

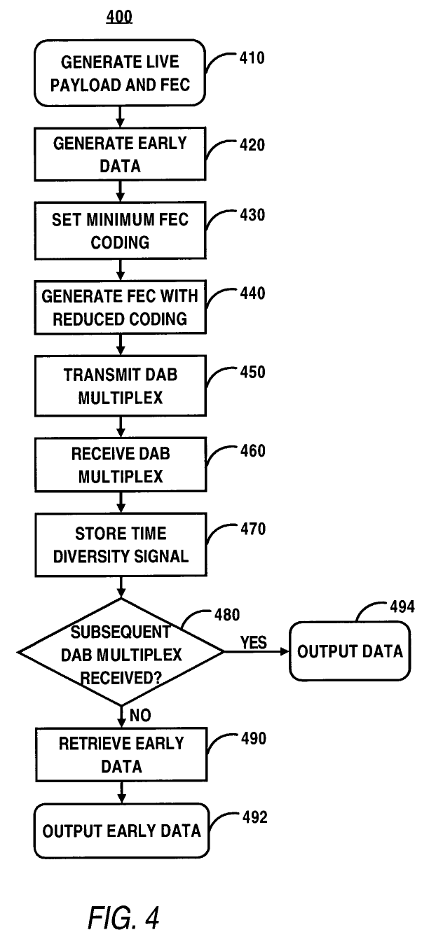

FIG. 4 illustrates a flow diagram of a method 400 for reducing the amount of channel coding overhead, such as the overhead 240 (shown in FIG. 2), for early time-shifted data, such as the data 230 (shown in FIG. 2). The channel coding overhead may include FEC data, and the like. In step 410, a DAB transmitter generates a live payload and associated FEC overhead for the live payload (e.g., live payload data 210 and associated overhead 220, shown in FIG. 2) to be transmitted in a DAB multiplex. In step 420, the DAB transmitter generates early time-shifted data (e.g., the early time-shifted data 230, shown in FIG. 2) for a time diversity signal to be transmitted in the DAB multiplex.

In step 430, the transmitter sets a minimum amount of data that may be used in the early time-shifted overhead (e.g., the FEC overhead 240, shown in FIG. 2) for the early time-shifted data of the diversity signal. This minimizes the amount of channel coding overhead for the early time-shifted data to conserve bandwidth. Traditionally, in digital communication systems, the error correction overhead range between half and twice of the useful payload (i.e., between half and twice the early time-shifted data 230 is duplicated in the FEC for the overhead 240). The overhead may be reduced to less than or equal to approximately half of the early time-shifted data.

In step 440, the DAB transmitter generates early time-shifted overhead (e.g., the overhead 240, shown in FIG. 2) for the early time-shifted data of the diversity signal. The amount of overhead is less than or equal to approximately the minimum amount determined in step 430. In step 450, the DAB transmitter transmits the DAB multiplex to DAB receivers.

In step 460, a DAB receiver receives the DAB multiplex and stores the early time-shifted data from the time diversity signal in memory (step 470). In step 480, the receiver determines whether it received a subsequently generated DAB multiplex. For example, the receiver may expect to receive a DAB multiplex periodically. If the DAB multiplex is not received, for example, due to an obstruction, the DAB receiver retrieves the previously received early time-shifted data from the memory (step 490). The DAB receiver may output the retrieved data, which may include outputting data through speakers for audio data (step 492). If the subsequent DAB multiplex is received, as determined in step 480, the receiver provides the DAB service, such as generating audio output of audio data in the received DAB multiplex (step 494).

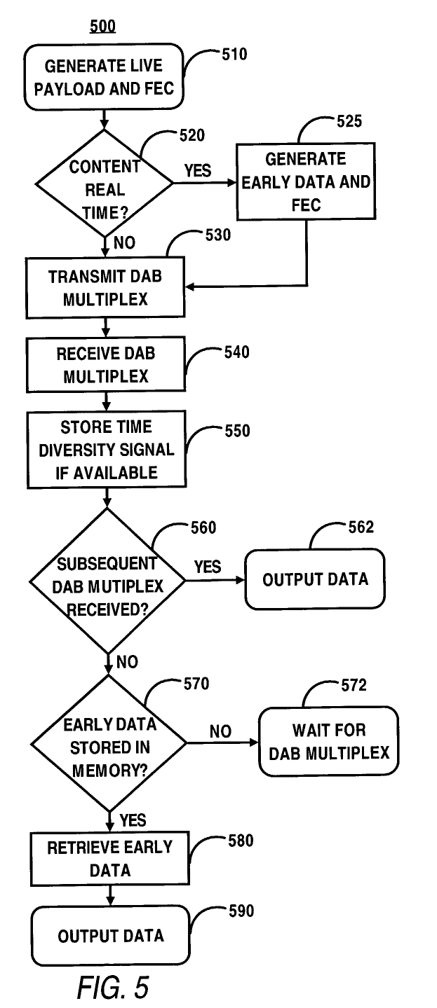

FIG. 5 illustrates a method 500 for conserving bandwidth in a DAB multiplex, according to an embodiment of the invention. In step 510, a DAB transmitter generates a live payload and associated FEC overhead for the live payload (e.g., live payload data 210 and associated overhead 220, shown in FIG. 2) to be transmitted in a DAB multiplex.

In step 520, the DAB transmitter determines whether content to be transmitted includes real time data services. This may further include examining content to determine whether it is data carrouselled (usually flagged by some type of index field in a DAB frame to describe the type of content). For example, the DAB transmitter analyzes the type of content that is being broadcasted to determine whether time diversity is needed. For a DAB system, in addition to audio and narrow band video entertainment broadcast, non real-time data may be broadcasted. Because of the nature of this type of data (e.g., weather, news, information flashes, stocks updates, etc.), this data may be refreshed on a periodic basis (e.g., every 5 to 20 minutes or on the hour). This data refreshing technique, sometimes referred as a “data carrousel” technique, provides multiple chances for data to be broadcasted and stored by the receiver. For this type of content, using the time diversity technique would likely be a waste of resources as the carrousel could be considered a “20 minute delay” time diversity technique.

If the content does not include real time data, the DAB transmitter generates a DAB multiplex including the content and transmits the DAB multiplex (step 530). In step 525, if the content includes real time data, the transmitter generates a DAB multiplex including a time diversity signal (i.e., early time-shifted data and FEC overhead). The DAB multiplex is transmitted to one or more receivers (step 530).

In step 540, a DAB receiver receives the DAB multiplex and stores the early time-shifted data from the time diversity signal in memory if the DAB multiplex includes early time-shifted data (step 550). In step 560, the receiver determines whether it received a subsequently generated DAB multiplex. For example, the receiver may expect to receive a DAB multiplex periodically. If the subsequent DAB multiplex is received, the receiver provides the DAB service, such as generating audio output of audio data in the received DAB multiplex (step 562). If the subsequent DAB multiplex is not received, for example, due to an obstruction, the DAB receiver determines whether early time-shifted data is stored in the memory that is associated with non-received data (step 570). If early time-shifted data is stored in memory, the early time-shifted data is retrieved (step 580) and output by the receiver (step 590). If no associated early time-shifted data is stored in the memory, the receiver defaults to the previous data stored or waits for the next DAB multiplex carrousel (step 572) transmitted from the DAB transmitter that includes data associated with the non-received data. This may include non-real time data that is periodically updated.

Although illustrated as individual methods, the methods 300-500 may be performed in conjunction with each other. For example, in method 300, after step 320, step 430 of method 400 may be performed such that the amount of FEC overhead coding for the early time-shifted data may be reduced. Also, the step 520 in the method 500 may be performed prior to generating early time-shifted data in either of the methods 300 and 400. Therefore, bandwidth may be conserved if it is not necessary to generate a time diversity signal, such as for non-real time data.

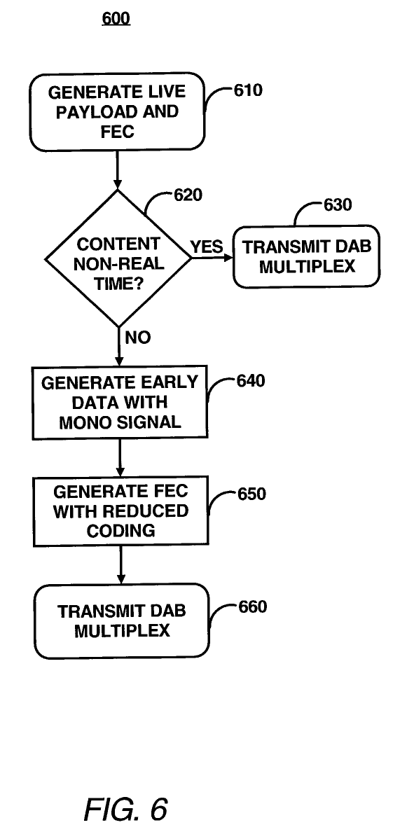

FIG. 6 illustrates an exemplary method 600 that may be performed by a DAB transmitter. The method 600 combines steps of the methods 300-500. In step 610, a DAB transmitter generates a live payload and associated FEC overhead for the live payload (e.g., live payload data 210 and associated overhead 220, shown in FIG. 2) to be transmitted in a DAB multiplex.

In step 620, the DAB transmitter determines whether content to be transmitted includes real time data. This may further include examining content to determine whether it is data carrouselled. For example, the DAB transmitter analyzes the type of content that is being broadcasted to determine whether time diversity is needed. For a DAB system, in addition to audio and narrow band video entertainment broadcast, non real-time data may be broadcasted. Because of the nature of this type of data (e.g., weather, news, information flashes, stocks updates, etc.), this data may be refreshed on a recurring basis (e.g., every 5 to 20 minutes or on the hour). This data refreshing technique, sometimes referred as a “data carrousel” technique, provides multiple chances for data to be broadcasted and stored by the receiver. For this type of content, using the time diversity technique would likely be a waste of resources.

If the content does not include real time data, the DAB transmitter generates a DAB multiplex including the content and transmits the DAB multiplex (step 630). If the content includes real time data, the transmitter generates a DAB multiplex including a time diversity signal (i.e., early time-shifted data and FEC overhead). In step 640, if the content includes real time data, the DAB transmitter generates the early time-shifted data for the time diversity signal. For example, if the content being transmitted in the live payload includes digital, audio, stereo data, the early time-shifted data may be comprised of mono, audio data to conserve bandwidth. The mono data may be duplicated by a receiver to simulate a stereo signal, if the early time-shifted data is needed.

In step 650, the DAB transmitter generates the FEC overhead with minimal coding for the time diversity signal. For example, in step 430, the transmitter sets a minimum amount of data (e.g., approximately half of the early time-shifted data) that may be used in the FEC overhead for the early time-shifted data of the diversity signal. This minimizes the amount of channel coding overhead for the early time-shifted data to conserve bandwidth.

In step 660, the DAB transmitter transmits the DAB multiplex including the time diversity signal to one or more receivers.

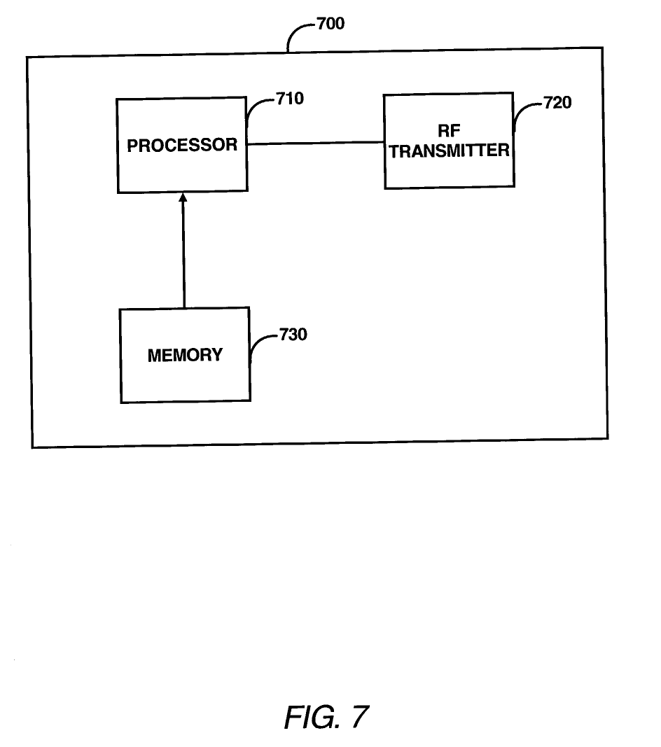

FIG. 7 illustrates a DAB transmitter 700, according to an embodiment of the invention. The DAB transmitter 700 may include a processor 710 connected to an RF transmitter 720. The processor may also include a memory 730 for storing a DAB media content for transmission. The processor may generate a live payload (DAB media content) and a time diversity signal, according to one or more of the methods 300-600 described above, for transmission to one or more DAB receivers.

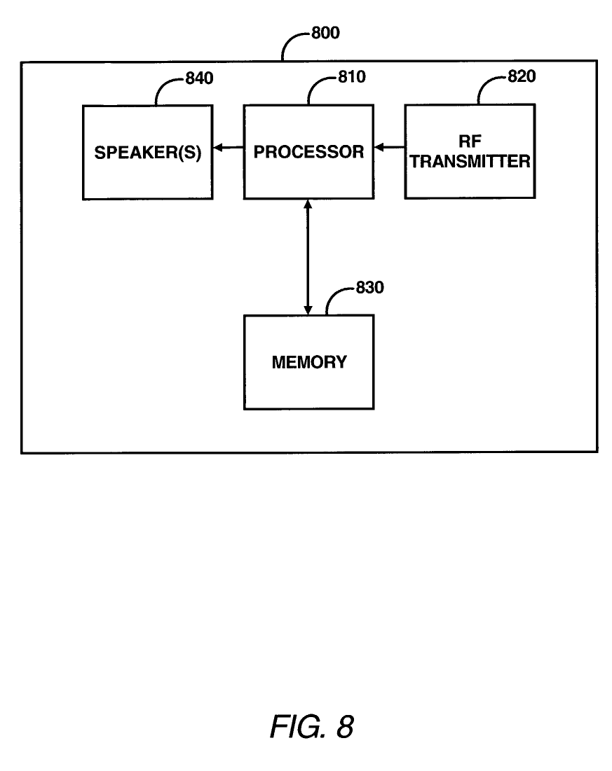

FIG. 8 illustrates a DAB receiver 800, according to an embodiment of the invention. The DAB 800 receiver includes a processor 810 connected to an RF receiver 820 and a memory 830. The RF receiver 820 may receive a DAB multiplex from the transmitter and store DAB media content, including time-shifted early data, in the memory 830. The DAB receiver 800 may output audio media content on speaker(s) 840. The DAB receiver 800 may perform one or more steps in the methods 300-500. It will be apparent to one of ordinary skill in the art that the DAB transmitter 700 and the DAB receiver 800, shown in FIGS. 7 and 8 respectively, are high level block diagrams, and the DAB transmitter 700 and receiver 800 may include a number of known components not shown.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A method of generating a signal for transmitting content to mobile users in an RF impaired environment, the method comprising:
generating a live payload including digital, audio, stereo content;
generating a time diversity signal including mono audio data associated with the digital, audio, content; and
transmitting the live payload and the time diversity signal.

2. The method of claim 1, wherein the digital, audio, stereo content and the mono audio data are digital audio broadcasting (DAB) content, and the step of transmitting further comprises transmitting the live payload and the time diversity signal in a DAB multiplex.

3. The method of claim 2, further comprising steps of:
receiving the DAB multiplex;
storing the time diversity signal in memory;
determining whether a subsequent DAB multiplex is received;
retrieving the stored time diversity signal in response to the subsequent DAB multiplex not being received; and
duplicating the mono audio data to generate a simulated stereo output.

4. A method of generating a signal for transmitting content to mobile users in an RF impaired environment, the method comprising:
generating a live payload including content;
generating an early time-shifted data for a time diversity signal associated with the content;
setting a minimum amount of data for forward error correction associated with the early time-shifted data;
generating forward error correction data for the early time-shifted data, an amount of the forward error correction data being greater than or equal to the minimum amount; and
transmitting the live payload and the time diversity signal, the time diversity signal including the early time-shifted data and the forward error correction data.

5. The method of claim 4, further comprising a step of generating forward error correction data for the live payload, wherein an amount of forward error correction data for the live payload is greater than the minimum amount of forward error correction data for the early time-shifted data.

6. The method of claim 5, wherein the minimum amount of forward error correction data for the early time-shifted data is approximately equal to one-half of an amount of the early time-shifted data.

7. The method of claim 6, wherein an amount of the forward error correction data for the live payload is approximately equal to or approximately twice an amount of the live payload data.

8. The method of claim 5, wherein the step of transmitting further comprises transmitting the live payload, forward error correction data for the live payload and the time diversity signal.

9. The method of claim 4, wherein the step of transmitting further comprises transmitting the live payload and the time diversity signal in a digital audio broadcasting multiplex.

10. A method of generating a signal for transmitting content to mobile users in an RF impaired environment, the method comprising:
determining whether the content includes real time data;
generating a live payload and a time diversity signal for transmitting the content in response to the content including real time data; and
generating a live payload without a time diversity signal in response to the content including non-real time data.

11. The method of claim 10, further comprising steps of:
transmitting the live payload and the time diversity signal in a digital audio broadcast multiplex in response to the content including real time data; and
transmitting the live payload without a time diversity signal in the digital audio broadcast multiplex in response to the content including non-real time data.

12. A system for generating a signal for transmitting content comprising:
at least one transmitter transmitting content to a plurality of receivers, wherein the at least one transmitter is operable to determine whether the content includes real time data, and generates a live payload and a time diversity signal for transmission to the plurality of receivers in response to the content including real time data.

13. The system of claim 12, wherein the at least one transmitter is operable to transmit the content without a diversity signal in response to the content being non-real time data.

14. The system of claim 12, wherein the time diversity signal includes one or more of early time-shifted data and forward error correction data associated with the early time-shifted data and the transmitter is operable to limit an amount of data in one or more of the early time-shifted data and the forward error correction data.

15. The system of claim 14, wherein the early time-shifted data for the time diversity signal includes mono, audio data.

16. The system of claim 14, wherein an amount of the forward error correction data is less than or equal to a predetermined threshold.

17. The system of claim 12, wherein the system includes a digital audio broadcasting system.

18. The system of claim 17, wherein the transmitter transmits the live payload and the time diversity signal in a digital audio broadcasting multiplex.

19. The system of claim 18, wherein the transmitter transmits the digital audio broadcasting multiplex, an index schedule of a composition of the multiplex and associated channel coding rates in a digital audio broadcasting frame.

20. A transmitter operable to generate a signal for transmitting content, the transmitter comprising:
a processing means for determining whether the content includes real time data and for generating a live payload and a time diversity signal in response to the content including real time data; and
a transmitting means for transmitting the live payload and the time diversity signal.

21. The transmitter of claim 20, wherein the time diversity signal includes one or more of early time-shifted data and forward error correction data associated with the early time-shifted data and the processing means limits is operable to limit an amount of data in one or more of the early time-shifted data and the forward error correction data.

22. The transmitter of claim 21, wherein the early time-shifted data for the time diversity signal includes mono, audio data.

23. The transmitter of claim 21, wherein an amount of the forward error correction data is less than or equal to a predetermined threshold.

24. The transmitter of claim 20, wherein the transmitter means transmits the live payload and the time diversity signal in a digital audio broadcasting multiplex.
